(19) United States
(12) Patent Application Publication
(10) Pub. No.: US 2007/0109819 A1
(43) Pub. Date: May 17, 2007

(54) Modulated tuned L/C transmitter circuits

(76) Inventor: George Leonard Powell, Canning Vale (AU)

Correspondence Address: BARNES & THORNBURG LLP, P.O. BOX 2786, CHICAGO, IL, 60690-2786, US

(21) Appl. No.: 11/281,338

(22) Filed: Nov. 17, 2005

(51) Int. Cl. H02M 3/335

(52) U.S. Cl. 363/21.02

(57) ABSTRACT

A transmitter circuit for generating a modulated oscillating output signal, comprises a tuned inductor-capacitor resonant circuit, and further comprise switching means for changing the resonant circuit capacitance by switching a capacitance into and out of circuit, wherein the resulting change in resonant circuit output is used to provide modulation of the output with a data signal. The invention thus interrupts the resonant cycling of a resonant oscillator circuit to provide a modulation function, and this is achieved by switching the (or one of many) capacitors into and out of circuit.

### FIELD OF THE INVENTION

This invention relates to the use of resonant inductor capacitor circuits to provide modulated outputs, for example amplitude or frequency modulated radio frequency signals.

### BACKGROUND OF THE INVENTION

In radio frequency engineering much use is made of tuned circuits comprising an inductor and a capacitor or a mix of inductors and capacitors. The essential characteristic of a tuned circuit is its ability to respond to a particular frequency while rejecting all others. Series and parallel tuned circuits in the form of an inductor and a capacitor store energy, at one point in the oscillation in the inductor as a field and at another point as a charge in the capacitor. One of the limiting factors in using tuned circuits in radio frequency designs is the maximum speed of data transmission. To transmit data the AC voltage must be modulated or changed and so power has to be added to the tuned circuit or removed from it. Adding and removing power in anything but a quantum way results in the well known exponential growth and decay waveforms. The higher the Q of the system the more energy is stored and the more difficult it is to modulate the RF voltage. This results in data bandwidth limitation. If a very low Q coil is used it is easier to modulate the voltage however this is not good for a transmitting antenna as the power loss will be too large. Whereas rapid decay in a tuned circuit can be achieved by switching a damping resistor across the coil/capacitor and simply dissipating the power in the form of heat, dumping power into the tuned circuit to restore the oscillation is much more difficult to achieve.

In a typical 125 KHz RFID(radio frequency identification) antenna setup, power is delivered by a reader to a tuned circuit comprising a coil and a capacitor. Series and parallel tuned circuits can both be used. The electric current oscillating in the coil causes an inductive RF field that can be used to energize and communicate with special transponder devices called tags. Generally a tag consists of a pickup coil, a resonant capacitor and a microelectronic device with a data memory. Communication from the reader to the tag is effected by directly modulating the power in the reader antenna coil and communications from the tag to the reader by the tag remotely modulating the field by simply drawing more or less power from it.

As the data rate increases, both the reader and the transponder tag have progressively more difficulty in achieving the modulation for the reasons above. A means of providing a quantum addition and reduction in power is required to overcome these problems.

### SUMMARY OF THE INVENTION

According to the invention, there is provided a transmitter circuit for generating a modulated oscillating output signal, comprising a tuned inductor-capacitor resonant circuit, and further comprising:

switching means for changing the resonant circuit capacitance by switching a capacitance into and out of circuit, wherein the resulting change in resonant circuit output is used to provide modulation of the output with a data signal.

The invention thus interrupts the resonant cycling of a resonant oscillator circuit to provide a modulation function, and this is achieved by switching the (or one of many) capacitors into and out of circuit.

The tuned inductor-capacitor resonant circuit can comprise an inductor and a capacitor in parallel. A second capacitor can be provided in a third parallel branch, and this can enable the circuit to be switched between different output frequencies.

The tuned inductor-capacitor resonant circuit can instead comprise an inductor and a capacitor in series.

The switching means preferably comprises an electronic switch in series with the capacitor, and timing control means is provided for opening the electronic switch at a time within the cycle of the resonant circuit when substantially a maximum charge is stored on the capacitor. This is appropriate for amplitude modulation, and enables the circuit to resume operation seamlessly after the capacitor is switched back into circuit.

The electronic switch may be operated at a time within the cycle of the resonant circuit to include or remove capacitors when substantially a minimum charge is stored in the in-circuit capacitor. This is appropriate for a frequency modulation system.

A diode can be provided between the source and drain of a switching transistor, to allow current to flow in the reverse direction across the transistor. This enables the timing of operation of the switch to be less critical.

A second switching means can be provided in series with a shorting diode, the second switching means and the shorting diode being in parallel with the tuned inductor-capacitor resonant circuit. This can be used to prevent ringing in the circuit output.

The circuit of the invention can be used in a radio frequency tag system comprising a transmitter and a plurality of tags, each comprising receiving circuitry for receiving and demodulating the signal sent by the transmitter.

The invention also provides a method of providing amplitude modulation of a tuned inductor-capacitor resonant circuit, the method comprising:

switching the capacitor of the tuned inductor-capacitor resonant circuit out of circuit substantially at a point in time when maximum charge is stored on the capacitor to provide a modulation of a first amplitude; and

switching the capacitor of the tuned inductor-capacitor resonant circuit back in to circuit to provide a modulation of a second amplitude.

The invention also provides a method of providing frequency modulation of a tuned inductor-capacitor resonant circuit, the method comprising:

switching a capacitor of the tuned inductor-capacitor resonant circuit out of circuit substantially at a point in time when maximum energy is stored in the inductor to provide a modulation of a first frequency; and

switching the capacitor of the tuned inductor-capacitor resonant circuit back in to circuit at another time in the cycle when maximum energy is again stored in the inductor to provide modulation of a second frequency.

### BRIEF DESCRIPTION OF THE DRAWINGS

FIG. 1 shows various examples of known resonant circuits and resonant circuits of the invention;

FIG. 2 shows a timing diagram for Examples 3 and 6 of FIG. 1;

FIG. 3 shows a timing diagram for Example 9 of FIG. 1; and

FIGS. 4a and 4b show timing diagrams for Example 10 of FIG. 1.

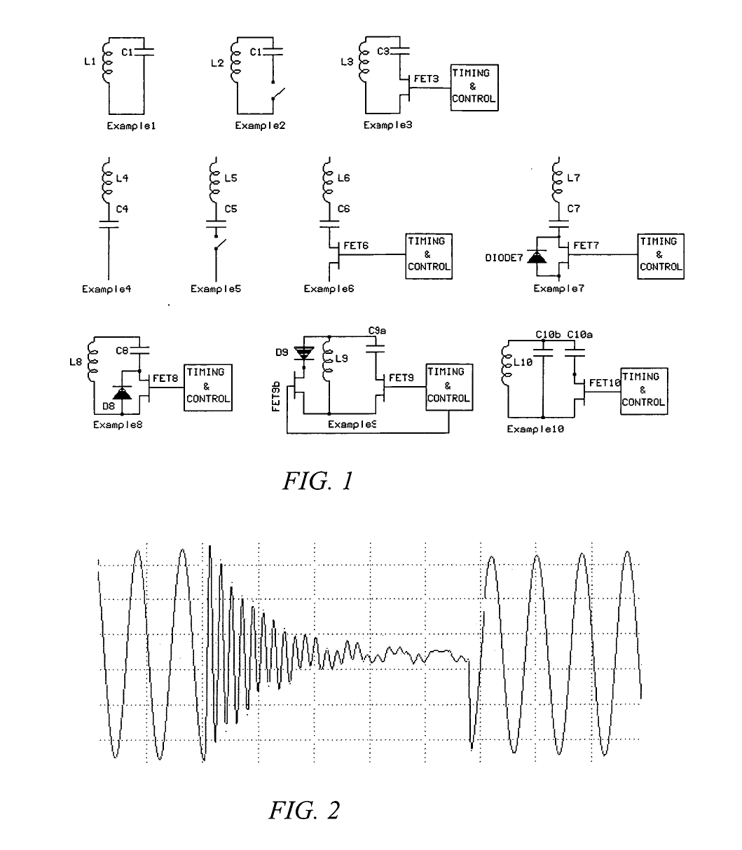

FIG. 1 shows various examples, numbered 1 to 10, of known tuned resonant circuits and resonant circuits of the invention. In all of these examples, the RF power feeds to the tuned circuits have not been shown for the sake of simplicity. The power source in can comprise a series choke from the power source to the top of the antenna coil.

The known inductor-capacitor tuned circuit, at its simplest is a coil and a capacitor. The power stored by the circuit is transferred alternately from the coil to the capacitor and back again. At most times some power is stored in both the inductor and the capacitor but at a particular point in the cycle all the power is stored in the coil and at another particular point in the cycle all the power is stored in the capacitor. These are the crucial moments.

When the voltage across the capacitor is at its peak all the power is stored in the capacitor. The invention is based on the realisation that at this point, the oscillation can be suspended by electrically removing the charged capacitor from the circuit or simply by isolating it. The RF field generation instantly ends. A benefit of this approach is that the charged capacitor can be electrically put back at any time later and the oscillation will continue as if it had never been suspended. This overcomes all the associated problems of pumping in power to build up the field and then destroying it by dissipating the power in a resistor.

Although most tag systems require the reader to amplitude modulate the tag, frequency modulation is also possible. In an alternative implementation of the invention, instead of waiting for all the energy to be stored in the capacitor, it is also possible to wait until the all the energy is stored in the inductor, which is the point when the capacitor is at zero voltage, and at this point switch in or out some capacitance. This will frequency-modulate the resonant circuit in a seamless way. For a tag tuned to a particular frequency this would be the much the same as if the oscillation had been removed entirely.

Embodiments of the invention in which amplitude modulation is suspended using a switched capacitor will first be described.

Example 1 of FIG. 1 shows a circuit of the well-known parallel tuned circuit comprising an inductor L1 and a capacitor C1.

Example 2 shows how, in accordance with the invention, the capacitor C2 can be isolated by means of a switch in series with the capacitor branch of the parallel circuit. The switch must be turned off precisely at the point C2 is filly charged. The generation of the inductive RF field is suspended and a perfect 100% modulation with zero decay time can be performed. The off time will be dependant on the data rate. With a perfect switch and a perfect capacitor the off period can be any amount of time. At the end of the off period, the switch is closed and simultaneously the RF power source is re-applied. The oscillation substantially restarts where it left off.

The switch can be implemented as shown in Example 3. The switch is shown as a field effect transistor FET3 that is used to perform the high speed switching. Driving FET3 is a timer and control unit that does all the timing and simultaneously controls the RF power generation. FET3 is turned off when C3 is at maximum charge and the power source is simultaneously turned off. The FET has a small leakage current, however for most purposes it is so small as to be insignificant. At the end of the off period the control unit turns the FET on and simultaneously resumes the generation of the RF power.

A coil with a Q (quality factor) of 50 or more is conventional and the circulating current in the coil and capacitor can be very large, much more than the current required to sustain the oscillation, and the FET must be correspondingly robust.

The timing and control unit can be a simple Microprocessor with a PWM (Pulse width Modulator). It should produce an even mark space ratio frequency output and synchronize this to the switching of the FET gate. Precise timing is not necessary in a practical unit as a diode can be used in conjunction with the switching FET and this will be explained later.

The control unit also stops the RF power generation at the point the capacitor is electrically removed and only restarts the power generation when the capacitor is switched back in circuit. The coupling of the power source to the resonant circuits has been omitted for simplicity. It may consist of an inductor taken to the top of the antenna coil, with a common ground. This applies to all the Examples of FIG. 1.

The application of the invention to series-tuned circuits is shown in Examples 4 to 6. Example 4 shows the well-known series resonant circuit.

Example 5 shows the position of the new isolating switch, in series with the capacitor and inductor, and Example 6 the implementation of this switch as FET6.

The configurations described above perform the required switching function and allow the suspension of oscillation. The timing of the switching needs to be accurate or the FET will switch when the charge is not completely stored in the tuning capacitor. Phase shifts can make the precise point difficult to set. As mentioned above, measures can be adopted to facilitate the timing control of the circuit.

Example 7 shows the use of a commuting diode (“Diode 7”) between the source and drain of the FET. In fact, manufacturers of most FETs already place diodes in the required position for avalanche protection so that many FETs do not require the additional diode. In Example 7, while FET7 is switched on the diode has no effect. The timing and control unit arranges FET7 to turn off while the electric current is negative. The current finds a path through D7 that is forward conducting in this direction, and the current continues until the capacitor C7 is at maximum negative charge. The diode naturally stops conducting when C7 is fully charged. C7 is in effect now isolated and the oscillation has been suspended. The oscillation is restarted as before by turning the FET7 back on.

In this way the tuned circuit can be 100% modulated in an efficient manner. The off periods must not be so long that the capacitor discharges through the various leakage paths, the diode D7 reverse current and the leakage through FET7. In most cases, these leakage currents will be negligible.

Example 8 shows the use of a commuting diode in the equivalent parallel-tuned circuit.

In real life, the stray capacitance of the circuit and off self-capacitance of the diode and the FET still present a capacitance to the coil and a small amount of ringing takes place.

FIG. 2 shows a High Q System with the drive circuit attached, and shows that in practice there will inevitably be a ring after the FET switch is made open circuit due to the capacitance of the device. This ringing can be seen as a decaying oscillation during the period when the oscillation is intended to be halted.

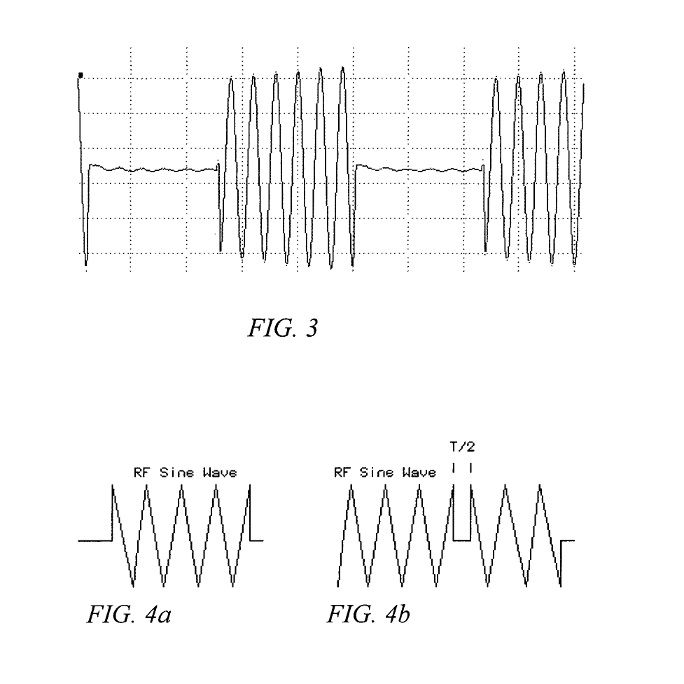

This ring can cause a problem especially as it is not well defined and can drift onto an undesirable frequency. This ring can be removed, to provide the waveform shown in FIG. 3, which shows a High Q System with the Switch Off ring removed.

This improved waveform is attained by grounding the inductor with another FET switch in series with a fast diode, as shown in Example 9.

If the period between the pulses is T/2 then the oscillating field will have the effect of rapidly killing any oscillation on any remote resonant circuit in the field by feeding it reverse phase cycles. The number of cycles to kill the remote oscillation will depend on the coupling and the Q of the remote circuit.

In this example, the timing and control unit turns on a second FET9b and a series diode D9 that shorts the antenna coil at the same time that the tuning capacitor is being switched out to perform the modulation. The power causing the ringing is very small and is easily overcome. In practice, the commuting diode D9 is not perfect and other losses will cause a slight loss of oscillation power when the oscillation is restarted. In most instances, this loss is insignificant.

The examples above concentrate on the interruption of the oscillations to provide amplitude modulation. Indeed, the usual modulation technique for RFID Readers is amplitude modulation and not frequency modulation.

Example 10 shows how the invention can be applied to frequency modulation techniques. Example 10 shows a parallel-tuned resonant circuit (L10 and C10b) to which a second capacitor C10a, in a third parallel branch, is added. The resonant frequency of L10 and C10b may be changed by switching in the capacitance C10a. The timing and control unit must switch FET10 in when the voltage across C10b is zero. The frequency can be modulated by adding or subtracting capacitors while C10b is at zero voltage.

If the voltage is at zero then the energy is stored completely in the inductor and no energy is lost. Very fast and stable speeds of modulation may thus be achieved. No power will be lost or gained and there will be no significant bump in the output.

FIGS. 4a and 4b show how the circuit of Example 10 can use field reversal to enhance data speed.

FIG. 4a shows the normal RF output, and FIG. 4b shows the transmitter turning off and waiting for a period of T/2 where T is the cycle time and then it sending out a few more cycles in the opposite phase.

In this way, for example in an RFID system, the reader (transmitter) can be used to rapidly bring about a rapid decay in the remote transponder (receiver). The energy from the reader (transmitter) is then coupled to the transponder (receiver) and brings the oscillation in the receiver's tuned circuit to a rapid stop. The exact number of cycles required to exactly stop the remote circuit or transponder can be determined.

The invention thus provides a tuning system comprising one or more inductors, one or more capacitors and one or more electronic switch assemblies so that rapid amplitude modulation of the signal can be achieved by eliminating the growth and decay times associated with normal LC tuned circuits by switching in and out the capacitor/s. The invention can also be used to reduce the decay period in a remote antenna coil and tuning assembly by reversing the field for a given number of cycles, the number of reverse cycles depending on the particular performance parameters of the receiver or transponder. The invention enables the transmitting power of amplitude modulated systems used for data communications to be reduced, and the speed of data communication to remote receivers or transponders may be increased. In some examples, a diode is used to reduce the accuracy required in turning off an FET switch at the voltage peak of a tuned circuit. The invention can, for example, be used to control the power delivered to a standard rod antenna to promote rapid amplitude modulated data transmission. The method can also be used to control the power delivered to a remote antenna to enable rapid amplitude modulated data reception within a remote tuned receiver. The invention can also be used to implement frequency modulating tuned circuits with reduced power loss and bumping which is particularly relevant to power transmitters and inductive field generation.

1. A transmitter circuit for generating a modulated oscillating output signal, comprising a tuned inductor-capacitor resonant circuit, and further comprising:
switching means for changing the resonant circuit capacitance by switching a capacitance into and out of circuit, wherein the resulting change in resonant circuit output is used to provide modulation of the output with a data signal.

2. A circuit as claimed in claim 1, wherein the tuned inductor-capacitor resonant circuit comprises an inductor and a capacitor in parallel.

3. A circuit as claimed in claim 2, wherein the tuned inductor-capacitor circuit further comprises a second capacitor in a third parallel branch.

4. A circuit as claimed in claim 1, wherein the tuned inductor-capacitor resonant circuit comprises an inductor and a capacitor in series.

5. A circuit as claimed in claim 2, wherein the switching means comprises an electronic switch in series with the capacitor.

6. A circuit as claimed in claim 5, further comprising timing control means for opening the electronic switch at a time within the cycle of the resonant circuit when substantially a maximum charge is stored on the capacitor.

7. A circuit as claimed in claim 5, further comprising timing control means for opening the electronic switch at a time within the cycle of the resonant circuit when substantially a minimum charge is stored on the capacitor.

8. A circuit as claimed in claim 5, wherein the switching means comprises a transistor, and a diode is provided between the source and drain of the transistor to allow current to flow in the reverse direction across the transistor.

9. A circuit as claimed in claim 1, further comprising a second switching means in series with a shorting diode, the second switching means and the shorting diode being in parallel with the tuned inductor-capacitor resonant circuit.

10. A radio frequency tag system comprising a transmitter having a circuit as claimed in claim 1, and a plurality of tags, each comprising receiving circuitry for receiving and demodulating the signal sent by the transmitter.

11. A method of providing amplitude modulation of a tuned inductor-capacitor resonant circuit, the method comprising:
switching the capacitor of the tuned inductor-capacitor resonant circuit out of circuit substantially at a point in time when maximum charge is stored on the capacitor to provide a modulation of a first amplitude; and
switching the capacitor of the tuned inductor-capacitor resonant circuit back in to circuit to provide a modulation of a second amplitude.

12. A method of providing frequency modulation of a tuned inductor-capacitor resonant circuit, the method comprising:
switching a capacitor of the tuned inductor-capacitor resonant circuit out of circuit substantially at a point in time when maximum energy is stored in the inductor to provide a modulation of a first frequency; and
switching the capacitor of the tuned inductor-capacitor resonant circuit back in to circuit at another point in the cycle time when maximum energy is again stored in the inductor to provide modulation of a second frequency.
